(19) United States
(12) Patent Application Publication
(10) Pub. No.: US 2024/0249298 A1
(43) Pub. Date: Jul. 25, 2024

(54) DEMAND SIDE MANAGEMENT FRAMEWORK

(71) Applicant: BIDGELY, INC., MOUNTAIN VIEW, CA (US)

(72) Inventors: NISHA AGARWAL, GUJARAT (IN); BASANT KUMAR PANDEY, KARNATAKA (IN); SAHANA M, BENGALURU (IN)

(21) Appl. No.: 18/420,693

(22) Filed: Jan. 23, 2024

Related U.S. Application Data
(60) Provisional application No. 63/440,794, filed on Jan. 24, 2023.

(51) Int. Cl. G06Q 30/0202; G06Q 50/06

(52) U.S. Cl. CPC G06Q 30/0202; G06Q 50/06

(57) ABSTRACT

In general, the present invention is directed to systems and methods for providing a demand-side energy framework to assist a utility in altering peak load demand, the method including: receiving inputs from a utility; receiving inputs resulting from a disaggregation algorithm being applied to energy usage data of a customer; determining a targeted set appliances and of associated homes or users, from whom changes in energy usage are desired; determining usage patterns of the targeted set of appliances; and determining, using a flag array computation, users and appliances for whom modification of behavior or energy usage may contribute to altering peak load demand.

### RELATED APPLICATIONS

The present application claims priority to U.S. Provisional Patent Application No. 63/440,794, filed 24 Jan. 2023, entitled “Demand Side Management Framework,” which is incorporated by reference herein in its entirety.

### BACKGROUND

With a rise in economic and technological development, energy demand is growing, and it has become a challenging task for electric utilities to ensure a reliable power supply. For instance, in the coming years, the rise of electric vehicles (EVs) may increase the load on the grid. To accommodate the surge in electric demand, utilities may have to adopt either expansion of generation plants or systems or methods that may utilize Demand Side Management (DSM). Demand Side Management (DSM), in general, may be understood as modifying consumer-side demand for energy to ensure that energy demand never crosses a desired limit. DSM programs may not guarantee a decrease in total consumption but may help in lessening the need for investment in power plants to meet the increasing demand and, at the same time, ensure grid reliability. One goal may be to mitigate an individual's energy needs during peak hours without compromising the overall lifestyle.

Current demand-side management methods generally include energy efficiency and demand response programs designed to reduce peak load or shift the demand from peak to off-peak hours. These include surging energy charges during peak demand hours. These methods may lead to a shift of a large portion of demand from peak hours to off-peak hours, leading to an undesirable change in the demand curve.

Prior art systems and methods have numerous drawbacks. For example, agent-based approaches are not feasible to be deployed in all regions. Methods based on consumption scheduling that use linear programming do not take into account appliance level complexities involved in load reschedules. Optimization frameworks set forth in prior art systems and methods generally do not suit all appliances in practice. A direct load control (DLC) mechanism described in multiple papers, may not fit utility objectives since it requires agreement between the utility and customer to control the appliances to modify the demand curve remotely. Few techniques for smart energy pricing mentioned may drive customers to shift their load away from peak hours. On the contrary, it may also be difficult for customers to schedule usage as per the prices that are changing every hour and may also lead to a shift of a large portion of demand from peak hours to off-peak hours leading to undesirable change in demand curve. If existing demand response methods were more user and appliance centric, the likelihood of achieving the objective demand curve may increase.

Existing methods are naive and usually contain a small set of non-personalized actions that do not guarantee the required reshaping of the demand curve. These non-user-centric approaches do not incorporate the prior knowledge of user preferences. Therefore, there is a need for a concrete load scheduling mechanism to execute the demand response programs that should target appliances contributing significantly to the increased demand on the grid and decrease the uncertainties in the DSM initiative. Such a user-centric approach may also increase the likelihood of consumers taking steps towards fulfilling utility goals.

### SUMMARY OF THE INVENTION

In accordance with some embodiments of the present invention, an intelligent demand-side energy management framework which may assist utilities in altering peak load demand is presented. Such a framework may be configured to optimize appliance behavior based on the utility objectives and may generate personalized and actionable insights for each consumer. Utility objectives may include, but are not limited to, reducing peak demand or shifting peak load to off-peak hours. The framework may allow the targeting of specific appliances, such as but not limited to pool pumps, water heaters, HVAC devices, and/or electric vehicles. It may provide a ranked list of potential consumers for a given DSM program and their respective appliance action and recommended rate plan.

In accordance with some embodiments of the present invention, the present invention may be directed to a method of providing a demand-side energy framework to assist a utility in altering peak load demand, the method comprising: receiving inputs from a utility; receiving inputs resulting from a disaggregation algorithm being applied to energy usage data of a customer; determining a targeted set appliances and of associated homes or users, from whom changes in energy usage are desired; determining usage patterns of the targeted set of appliances; and determining, using a flag array computation, users and appliances for whom modification of behavior or energy usage may contribute to altering peak load demand.

In accordance with some embodiments of the present invention, the present invention may be directed to a method of providing a demand-side energy framework to assist a utility in altering peak load demand, the method comprising: receiving inputs from a utility identifying targeted homes or users from whom the utility desires to reduce energy consumption during specific times; receiving inputs resulting from a disaggregation algorithm being applied to energy usage data of a customer; determining a targeted set appliances and of associated homes or users, from whom changes in energy usage are desired; determining usage patterns of the targeted set of appliances; determining, using a flag array computation, users and appliances for whom modification of behavior or energy usage may contribute to altering peak load demand; and generating a probability score of the associated users based at least in part on: the amount of energy each associated user may contribute to altering peak load demand; and the likelihood of the user performing an action suggested to alter peak load demand.

In accordance with some embodiments of the present invention, the present invention may be directed to a system for providing a demand-side energy framework to assist a utility in altering peak load demand, the system configured to: receive inputs from a utility identifying targeted homes or users from whom the utility desires to reduce energy consumption during specific times; receive inputs resulting from a disaggregation algorithm being applied to energy usage data of a customer; determine a targeted set appliances and of associated homes or users, from whom changes in energy usage are desired; determine usage patterns of the targeted set of appliances; determine, using a flag array computation, users and appliances for whom modification of behavior or energy usage may contribute to altering peak load demand; and generate a probability score of the associated users based at least in part on: the amount of energy each associated user may contribute to altering peak load demand; and the likelihood of the user performing an action suggested to alter peak load demand.

The foregoing summary is only illustrative in nature and is not intended to be in any way limiting. In addition to the illustrative aspects, embodiments, and features described above, further aspects, embodiments, and features will become apparent by reference to the drawings and the following detailed description.

### DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 depicts an exemplary system, in accordance with some embodiments of the present invention.

FIG. 2 illustrates an exemplary graph illustrated an original demand curve versus a modified demand curve is shown, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure. In addition, note that the order of steps of any process or method discussed herein or illustrated in the figures is exemplary and not to be construed as limiting.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments. The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In general, the present invention is directed to a demand-side management load scheduling strategy that may be easily used for intelligent grid management to increase the reliability of power supply and minimize the operation cost for the utility. In accordance with some embodiments of the present invention, the framework set forth herein may calculate personalized actions for each potential user to cater to the utility's objective. The framework may rank users based on their propensity to contribute toward the utility's objective. Customized actions (rather than generic “save energy” suggestions) may decrease the uncertainties in a DSM initiative and increase customer likelihood to take action towards the utility's goals.

Behavioral demand response programs may be more effective when framed around data-driven personalization. Meeting customers where they are, with an understanding of their specific energy use needs and habits may translate into messaging that may be more impactful. Moreover, without personalization and relevance, utilities may risk creating a sense of “peak event fatigue,” in which customers may become less interested in participating over time because calls to action are vague and don't set forth specific behaviors to modify. Rather, it may be beneficial for utilities to educate customers about their specific energy use on a per-appliance and even day-and-time-of-use basis.

Establishing a one-to-one consumer understanding that may serve as a foundation for a personal approach is disaggregation and energy data. Granular energy insights may a customer's energy use journey to be hyper-personalized with a clear explanation of the benefits for taking specific actions.

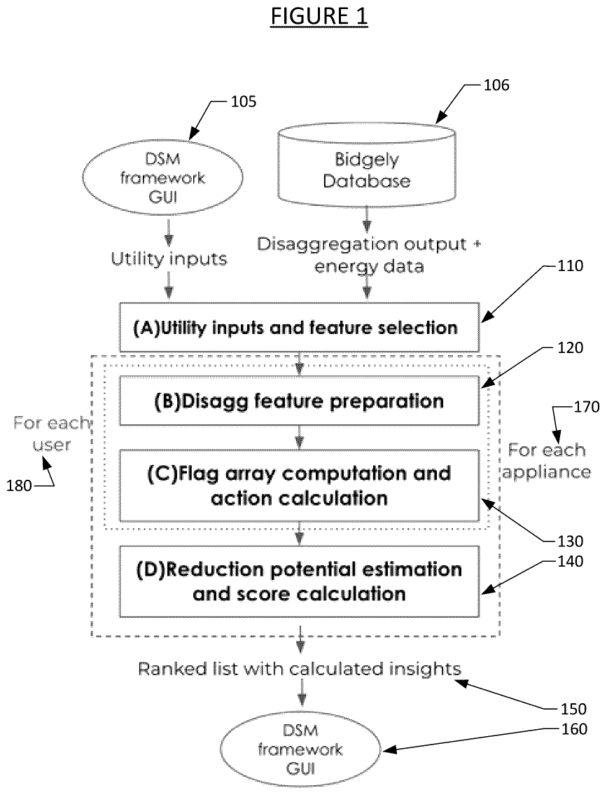

In general, and with reference to FIG. 1, systems and methods of the present invention may utilize a process utilizing inputs from a utility via a demand side management (“DSM”) framework graphic user interface (“GUI”) 105 and disaggregation output and energy data from a private database 106. The utility inputs 105 may generally comprise specific desires or objectives, such as reducing loads in certain portions of the grid, as well as other details that may be relevant to such a program, including messages, budgets, etc. The disaggregation output and energy data 106 may generally comprise leverage advanced metering infrastructure (AMI) data, as well as utility contributed consumer data and give detailed visibility to customer usage of specific appliances (or appliance types), when customer use such appliances, how much usage each of the appliances represents, consumer-specific behavior such as frequency of use, run-times, efficiency, etc, and additional appliance attributes.

As set forth in greater detail below, the process may comprise (i) utility inputs and feature selection 110; (ii) disaggregation feature preparation 120; (iii) flag array computation and action calculation 130; and (iv) reduction potential estimation and score calculation 140, which may result in a ranked list with calculated insights 150. Such ranked list and insights 150 may be provided back to the DSM framework GUI for subsequent use. As discussed below, determinations and insights may be generated for each user and/or for each appliance or appliance type.

Utility Inputs and User Selection. As noted above, a first step may be utility inputs and feature selection 110. More specifically, a set of homes targeted by a utility may be identified. These target homes may be provided by the utility or filtered based on preferences with zipcodes or appliances. After specifying the users and appliance requirements, the utility may either choose to: (i) reduce consumption during specific hours of the day; (ii) reduce consumption on certain days of the month; (iii) reduce a given amount of energy usage; and/or (iv) ensure the total consumption does not exceed a specific limit.

An objective function may be formulated based on utility requirements. The exemplary process mentioned below may be defined to maintain the hourly load within the limit one (l) units, i.e., the maximum required hourly demand provided by the utility. “Pij” is the total energy consumption of a user “j” at hour “i,” “T” is the set of hours where total demand exceeds the limit one (l), “Y” is the set of all target users, and “H” is the set of hours in the day ranging from zero (0) to twenty-three (23).

$$Objective function : {\sum }_{i ∈ T} ( {\sum }_{j ∈ Y} {P}_{ij} - l )$$

$$Constraint : max \{ {\sum }_{j ∈ Y} {P}_{ij} : i ∈ H \} <= l$$

$$T = \{ i : i where {\sum }_{j ∈ Y} {P}_{ij} > l \}$$

Disaggregation Feature Preparation. After obtaining a list of users and appliances, the framework may determine usage patterns of the target appliances. This may be based at least in part on disaggregation feature presentation 120, and may include, but is not limited to, features of: time of use, total consumption in peak hours, frequency of appliance usage, etc. The framework may also compute a user's behavioral parameters, such as occupancy hours, sleeping time, etc.

After obtaining a utility's preference in target homes and appliances, in accordance with some embodiments of the present invention a disaggregation algorithm may be used to determine the usage pattern of one or more target appliances. The disaggregation algorithm may provide usage behavior for appliances or groups of appliances such as, but not limited to, water heaters, pool pumps, electric vehicles (EV), cooling appliances, heating appliances. Disaggregated data may be utilized to determine features such as time of use, total consumption in peak hours, frequency of appliance usage, etc. A user's behavioral patterns or parameters, such as occupancy hours, sleeping times, vacation time, etc. may be determined.

Flag Array Computation and Action Calculation. Next, flag array computation and action calculation 130 may be performed. More specifically, when usage hours overlap with the utility's peak hours, the framework may calculate a start time for each overlapping appliance, which may be a new start time. This start time may be identified for some or all of the users to minimize the objective function while ensuring the utility-level constraints and multiple appliance-level factors, without substantially modifying consumer lifestyle. The framework may be designed to shift the appliance usage in an available band of hours, thus increasing the likelihood of a user considering and adopting the recommended action. This available band of hours may be stored in a form of flag array which is dependent upon multiple factors including but not limited to the lifestyle of the user, office going timings, sleeping hours, and temperature pattern. For instance, a water heater should be used before a user leaves the house at 7 am, or another user can charge their electric vehicle only after 9 pm. Taking in account such constraints, the framework may calculate actions for relevant combinations of appliance and user.

Note that disaggregation feature presentation and flag array computation and action calculation may be performed for each appliance 170, or each type of appliance. The process may output a ranked list with calculated insights at 150, which may be used to assist utilities in preparing a concrete DSM plan.

Shift Potential Estimation and Score Calculation. Systems and methods in accordance with the present invention may generate a probability score to one or more users based on the amount of energy they contribute to minimizing the objective function (shift potential) and their likelihood of performing the suggested action. Users may be further ranked based on this score, and a final ranked list of users with their actionable insights for all available appliances may be provided as the framework's output. The framework may also depict feasibility of attaining a particular DSM objective by indicating a determined maximum likely demand reduction in peak hours achievable for a given user set.

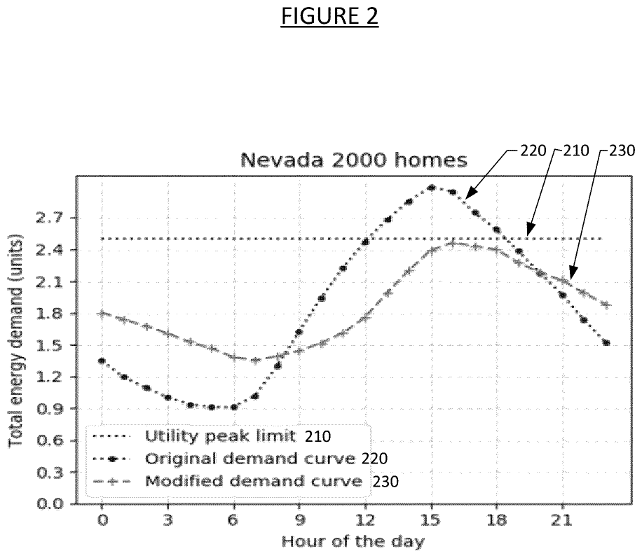

With reference to FIG. 2 exemplary results of the invention are shown. A simulation was performed on approximately 2000 Nevada homes, in an attempt to minimize energy demand by crossing the limit of 2.5 units. The hours where the limit initially exceeds are 12 pm to 6 pm, and the value of the objective function (the amount of energy exceeding the given limit) is 1.79 units. FIG. 2 illustrates the change in the demand curve of the targeted user set considering their specific recommended actions.

Electric Vehicle (EV) Case Study. In a given region, most consumers charge their electric vehicles between 9 pm to 2 am. The peak demand in that local grid is increasing, and a utility may want to take action towards the reduction of peak demand between 9 pm to 2 am. In accordance with some embodiments of the present invention, systems and methods may utilize a disaggregation algorithm to determine the houses that charge their electric vehicles at home and their respective charger types and charging hours for all given homes. The framework may then evaluate the new usage time for users (charging during peak hours), aiming to shift the demand away from peak hours. While optimizing the shifting of peak demand, user-level attributes such as lifestyle, EV charger type, and EV time of usage may be taken into consideration to determine the most suitable time of use for each user. A final ranked list of users, and their respective recommended action may be provided such that the utility may further target these homes to reduce peak demand.

In accordance with some embodiments of the present invention, demand-side management load scheduling strategy may be used for convenient and intelligent grid management to increase the reliability of power supply and minimize the operation cost for the utility. In addition, the systems and methods of the present invention may (i) calculate personalized actions for each potential user to cater to the utility's objective; (ii) rank users based on their propensity to contribute to the utility's objective; and/or (iii) through customized actions, decrease uncertainties in DSM initiatives while increasing the likelihood that the customer will take actions towards the utility's goal. The ranked list of users may assist utilities in preparing a concrete DSM plan. The ideas stated in this application can be extended to several directions involved in modifying the demand curve as per utility needs.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method of providing a demand-side energy framework to assist a utility in altering peak load demand, the method comprising:
receiving inputs from a utility;
receiving inputs resulting from a disaggregation algorithm being applied to energy usage data of a customer;
determining a targeted set appliances and of associated homes or users, from whom changes in energy usage are desired;
determining usage patterns of the targeted set of appliances; and
determining users and appliances for whom modification of behavior or energy usage may contribute to altering peak load demand.

2. The method of claim 1 further comprising generating a probability score of the associated users based at least in part on:
the amount of energy each associated user may contribute to altering peak load demand; and
the likelihood of the user performing an action suggested to alter peak load demand.

3. The method of claim 1, wherein the disaggregation algorithm utilizes training data from a database.

4. The method of claim 1, wherein the inputs from the utility comprise target homes or users determined by the utility to:
reduce consumption during specific hours of a day;
reduce consumption on certain days of a month;
reduce a given amount of energy usage; or
ensure that total consumption for the target home does not exceed a specific limit.

5. The method of claim 4, wherein an objective function is formulated based on utility requirements.

6. The method of claim 1, wherein the usage patterns of the targeted set of appliances is determined based at least in part on disaggregating previous energy usage data from the homes with which the targeted set of appliances are associated.

7. The method of claim 6, wherein the usage patterns of the targeted set of appliances is further determined based at least in part on:
time of use;
total consumption in peak hours;
frequency of usage of the targeted appliance;
occupancy hours of the home; and/or
sleeping time of users within the home.

8. The method of claim 1, wherein the disaggregation algorithm outputs usage behavior for appliances or groups of appliances, comprising water heaters, pool pumps, electric vehicles and chargers, heating appliances, and/or cooling appliances.

9. The method of claim 1, wherein determining users and appliances is performed using a flag array computation, which determines utility peak hours and start times for targeted appliance usage for appliances whose usage overlaps with the utility peak hours.

10. The method of claim 9, wherein it is further determined if a change in targeted appliance usage can be accomplished without substantially modifying the user's lifestyle.

11. The method of claim 10, wherein the user's lifestyle is categorized by an available band of hours for appliance shifting, temperature patterns, and/or occupancy times.

12. A method of providing a demand-side energy framework to assist a utility in altering peak load demand, the method comprising:
receiving inputs from a utility identifying targeted homes or users from whom the utility desires to reduce energy consumption during specific times;
receiving inputs resulting from a disaggregation algorithm being applied to energy usage data of a customer;
determining a targeted set appliances and of associated homes or users, from whom changes in energy usage are desired;
determining usage patterns of the targeted set of appliances;
determining, using a flag array computation, users and appliances for whom modification of behavior or energy usage may contribute to altering peak load demand; and
generating a probability score of the associated users based at least in part on:
the amount of energy each associated user may contribute to altering peak load demand; and
the likelihood of the user performing an action suggested to alter peak load demand.

13. The method of claim 12, further comprising communicating with a user with a suggestion to modify behavior to reduce energy consumption and associated peak load demand from the utility.

14. A system for providing a demand-side energy framework to assist a utility in altering peak load demand, the system configured to:
receive inputs from a utility identifying targeted homes or users from whom the utility desires to reduce energy consumption during specific times;
receive inputs resulting from a disaggregation algorithm being applied to energy usage data of a customer;
determine a targeted set appliances and of associated homes or users, from whom changes in energy usage are desired;
determine usage patterns of the targeted set of appliances;
determine, using a flag array computation, users and appliances for whom modification of behavior or energy usage may contribute to altering peak load demand; and
generate a probability score of the associated users based at least in part on:
the amount of energy each associated user may contribute to altering peak load demand; and
the likelihood of the user performing an action suggested to alter peak load demand.
